(19) United States
(12) Patent Application Publication
(10) Pub. No.: US 2017/0056260 A1
(43) Pub. Date: Mar. 2, 2017

(54) CASTER WHEEL ARRANGEMENT

(71) Applicant: REAC AB, Amal (SE)

(72) Inventor: Carl Johan Olsson, Amal (SE)

(21) Appl. No.: 15/307,982

(22) PCT Filed: Apr. 29, 2014
(86) PCT No.: PCT/EP2014/058663

§ 371 Date: Oct. 31, 2016

(51) Int. Cl. A61G 5/06; B60B 33/00; A61G 5/04; B60B 33/06

(52) U.S. Cl. CPC A61G 5/061; B60B 33/066; B60B 33/0065; B60B 33/0049; A61G 5/04

(57) ABSTRACT

A caster wheel arrangement for a powered wheelchair, the caster wheel arrangement comprising: a caster wheel module comprising: a wheel rotatably connected to a first linkage member, wherein the wheel is rotatably arranged about a first axis of rotation of the wheel; and a support element rotatably connected to the first linkage member through a joint configured to allow a rotation of the first linkage member relative to the support element around a second axis of rotation perpendicular to the first axis of rotation; a second linkage member connected to the support element at a third axis of rotation, wherein the third axis of rotation is essentially perpendicular to the second axis of rotation of the first linkage member, to allow rotation of the caster wheel module about the third axis of rotation, wherein the third axis of rotation passes adjacent to the second axis of rotation.

### FIELD OF THE INVENTION

The present invention relates to a caster wheel arrangement for a powered wheelchair. The invention further relates to a method of controlling a caster wheel arrangement. The present invention also relates to a powered wheelchair having a caster wheel arrangement.

### BACKGROUND

Wheelchairs are important devices for people suffering from conditions which reduce their capability to walk, for example as a result of illness, injury, or disability. A wheelchair may increase the quality of life for millions of people suffering from such conditions.

More recently, electrically powered wheelchairs have become a more common solution for facilitating motion for affected persons, in particular persons suffering from more severe conditions. By enabling electrical power to drive the wheelchair the quality of life for, in particular severely affected people, is further improved since less manual operation is required. Hence, travelling longer distances is less exhausting with an electrically powered wheelchair. An electrical power source in a wheelchair also enables for sophisticated operations and functions, of the wheelchair, which may be electrically controlled and powered.

Some powered wheelchairs use at least one caster wheel, for example as disclosed by US20050127631. In addition, caster wheels are used in a variety of devices, for example in traditional shopping carts or on mobile office chairs. A caster wheel has a freedom of rotation such that the wheel is adapted to turn in a way that aligns with the drive direction of the wheelchair (or another device where the caster wheel is mounted) on the ground. For powered wheelchairs, this is important for efficient turning control of the wheelchair. However, as the powered wheelchairs become more sophisticated, higher requirements on safety are demanded.

Thus there is a need for improved driving control of powered wheelchairs.

### SUMMARY OF THE INVENTION

In view of the above, it is a general object of the present invention to provide an improved steering capability for powered wheelchairs.

The invention is defined in appended claim 1. Further preferred optional features thereof are defined in subsequent claims 2-19.

According to a first aspect of the present inventive concept, it is therefore provided a caster wheel arrangement for a powered wheelchair, the caster wheel arrangement comprising: a caster wheel module comprising: a wheel rotatably connected to a first linkage member, wherein the wheel is rotatably arranged about a first axis of rotation of the wheel; and a support element rotatably connected to the first linkage member through a joint configured to allow a rotation of the first linkage member relative to the support element around a second axis of rotation perpendicular to the first axis of rotation; a second linkage member connected to the support element at a third axis of rotation, wherein the third axis of rotation is essentially perpendicular to the second axis of rotation of the first linkage member, to allow rotation of the caster wheel module about the third axis of rotation, wherein the third axis of rotation passes adjacent to the second axis of rotation.

The present invention is in part based on the realization that a caster wheel arrangement allows a flexible steering with very small turning radius for a powered (or non-powered) wheelchair. A turning radius is the radius of curvature of a path of e.g. a powered wheelchair when turning. The flexible steering comes from the fact that the caster wheel may align with the driving direction of the wheelchair, thus when turning of the wheelchair the caster wheel rotates such that to align with the new driving direction. Furthermore, the present invention is based on the realization that by enabling a rotation of the caster wheel such that the second axis of rotation is tilted, thus tilted about the third axis of rotation, improved steering at high speed is possible. For example, a rotation about the third axis of rotation of the caster wheel module reduces a problem of oversteering since the ability for the caster wheel to rotate about the second axis of rotation is limited by tilting the second axis of rotation about the third axis of rotation. Oversteering is when a vehicle turns more (with a smaller radius of curvature) than expected. The invention thus provides for example, an adequate control of the wheelchair at high speeds, or high control of the wheelchair under normal operation.

A further advantage of the invention is that in situations where oversteering is not needed to be compensated for, for example at low speeds, the caster wheel module may continuously be controlled such that the second axis of rotation is maintained perpendicular to the ground in contact with the wheel. This way, the wheel rotates more easily about the second axis of rotation making full use of the caster wheel function.

A powered wheelchair is provided with a motor providing power for driving the wheelchair in a desired direction. The caster wheel arrangement arranged on the electric wheelchair provides for improved steering control of the powered wheelchair, in particular when turning. With the caster wheel arrangement, a driver may maintain the speed throughout a turning maneuver without compromising the steering or driving control of the wheelchair.

The first linkage member may be associated with a length (L1), the second linkage may similarly be associated with a length (L2). Hence the length of the first linkage member is L1 and the length of the second linkage member is L2. The lengths L1 and L2 may be a longitudinal length of the respective linkage member. The first axis of rotation is essentially perpendicular to at least a portion of the first linkage member along the length L1.

By the first linkage member being connected to the wheel in a way that allows the wheel to rotate in a rolling fashion around the first axis of rotation means, in other words, the wheel is allowed to rotate around the first axis of rotation if a force is applied tangentially to a substantially circular circumference of the wheel. The first linkage member may be connected to the wheel via e.g. a bolt or similar. A bearing may for example be arranged at a center of the wheel for providing the rotation capability of the wheel about the first axis of rotation.

The first linkage member may be rotatably connected at the first axis of rotation on one side of the wheel. Alternatively, the first linkage member may be rotatably connected at the first axis of rotation on both sides of the wheel, as long as the wheel is rotatably connected to the first linkage member. If the first linkage member is connected on both sides of the wheel, the first linkage member may be formed as a fork reaching to both sides of the wheel at the first axis of rotation.

According to the invention, the third axis of rotation passes adjacent to the second axis of rotation. In other words, the second linkage member is arranged such that the third axis of rotation passes adjacent to the second axis of rotation. Furthermore, the third axis of rotation may pass adjacent to the first linkage member. Improved oversteering reduction is enabled by arranging the second linkage member such that the third axis of rotation is adjacent to the second axis of rotation and preferably the first linkage member due to the resulting rotation direction of the caster wheel module. Alternatively, improved oversteering reduction is enabled by arranging the second linkage member such that the third axis of rotation is adjacent to the second axis of rotation or preferably the first linkage member. In the above cases, the third axis of rotation is substantially perpendicular to a driving direction of the powered wheelchair, thus rotating the caster wheel module about the third axis of rotation causes the second axis of rotation to be tilted towards or away from the driving direction of the powered wheelchair.

As an example, when the caster wheel arrangement is mounted on a powered wheelchair the caster wheel arrangement is arranged such that if the caster wheel module is rotated about the third axis of rotation the second axis of rotation is tilted towards a driving direction of the powered wheel chair. Thus, the third axis of rotation is essentially perpendicular to the driving direction of the powered wheel chair.

The wheel may be a non-powered wheel being a wheel which is not provided with electrical power for rotating the wheel about the axis of rotation of the wheel. Thus, the wheel may roll without being provided with power from an external power source. In other words, the wheel is allowed to freely rotate about the first axis of rotation as a response to a force.

The term perpendicular typically encompasses a small deviation from 90 degrees. For example, 85-95 degrees may still be considered to be within the term perpendicular. Furthermore, the provision that the first and second axes of rotation are perpendicular to each other may not necessarily imply that the first and second axes of rotation intersect. It should be readily understood that there may be an axis parallel to the e.g. the first (second) axis of rotation which is perpendicular to the second (first) axis of rotation. The above may also apply to the third axis of rotation with respect to the second axis of rotation.

The support element is arranged to be the connecting element between the first linkage member and the second linkage member. Furthermore, if the support element is rotated about the third axis of rotation, the support element is connected to the wheel such that the support element brings along the wheel in the rotation about the third axis of rotation. The support element is rotatably connected to the first linkage member such that a rotation of the wheel about the first axis of rotation is allowed.

According to at least one exemplary embodiment of the invention, the second linkage member may be rotatably connected to the support member. Thereby, a rotational coupling is possible for rotating the caster wheel module via any other type of rotational connection.

According to at least one exemplary embodiment of the invention, the third axis of rotation may pass adjacent to the center of the wheel. The center of the wheel may for example be the center of rotation of the wheel. “Adjacent” to the center of rotation of the wheel means that the third axis of rotation may pass through the wheel in at least one position of the wheel when rotating about the second axis of rotation. Thus, as the wheel rotates a full turn about the second axis of rotation via the joint and the first linkage member, the third axis of rotation intersects the wheel at least once. Center of rotation may be a position in the wheel along the first axis of rotation.

According to at least one exemplary embodiment of the invention, further comprising an engaging element for engaging to a surface, wherein the engaging element is arranged to be rotatable around the third axis of rotation. Thus, the engaging element may be arranged such that the engaging element may also be rotated around the third axis of rotation. The engaging element may for example be in the form of a bar or hook-like element which enables facilitated climbing over obstacles such as e.g. curbs or thresholds. Furthermore, the engaging element enables a break function for a vehicle comprising the caster wheel arrangement. During rotation of the engaging element about the third axis of rotation, the engaging element follows a path not intersecting with the wheel. A surface may for example be the ground on which the wheel is situated.

According to at least one exemplary embodiment of the invention, the engaging element is rotatably arranged to the support element, wherein the engaging element is rotatable about the third axis of rotation independent of the support element. In this way, the engaging element may be independently controlled which allows a flexible break function and/or climbing function using the engaging element.

According to at least one exemplary embodiment of the invention, the support element may comprise a compartment housing the wheel, wherein a portion of the wheel extends outside the compartment through an open end of the compartment. The compartment may for example be spherical, close to spherical or formed like a dome, or similar, as long as the compartment covers the wheel, except for at the open end. The compartment may also house the first linkage member. Furthermore, the housing forming the compartment is advantageously formed like a shell. The compartment enables efficient protection of the wheel and in some cases other parts such as the first linkage member and the joint. When the compartment is housing also the first linkage member and the joint, the first linkage member is connected via the joint to an inner surface of the compartment. Moreover, the shell and compartment like support structure further improves a gripping capability for the support element improving the break function and the obstacle elimination.

According to at least one exemplary embodiment of the invention, the third axis of rotation may pass adjacent to the center of the compartment. By arranging the second linkage member such that the third axis of rotation is close to the center of the compartment, the rotation of the caster wheel module around the third axis of rotation does not substantially interfere with the position of the powered wheelchair in the vertical direction. Thus, the wheel may still be in contact with the ground without any further feedback during rotation of the caster wheel module about the third axis of rotation.

According to at least one exemplary embodiment of the invention, the open end extends in a plane and is arranged opposite the joint with respect to the wheel. In this way, the wheel is allowed to touch a ground on which the wheel is supposed to roll. Furthermore, the open end allows a relatively large degree of rotation about the third axis of rotations without the engaging element coming to a position below the wheel such that the engaging element may touch the ground the wheel is in contact with.

In one embodiment of the invention, the engaging element may be a rough outside surface of the support element. Thus, the engaging element may comprise grooves and ribs on the outside surface. For example, the surface may be a surface similar to the surface of a terrain tire. The outside surface is a surface, opposite the inner surface of the compartment, facing the wheel. The rough surface enables an efficient gripping for overcoming an obstacle encountered for the caster wheel arrangement. Furthermore, the rough surface enables an efficient breaking function for a vehicle (e.g. a powered wheelchair) comprising the caster wheel arrangement.

According to at least one exemplary embodiment of the invention, the caster wheel module may comprise a gear wheel for enabling a rotation of the caster wheel module, the gear wheel arranged such that a centre axis of the gear wheel defines the third axis of rotation of the caster wheel module. The gear wheel has a substantially circular outer circumference. The gear wheel may be fixed to the support element in a way that if the gear wheel is rotated about the third axis of rotation, the gear wheel causes the support element to be rotated about the third axis of rotation. In this way, a convenient manner for rotating the caster wheel arrangement about the third axis of rotation is obtained.

According to yet another embodiment of the invention, the second linkage member may comprise a rotation member, wherein the gear wheel is connected to the rotation member arranged on the second linkage member and configured to transfer a rotation of the second linkage member into a rotation of the caster wheel module via the gear wheel and the rotation member. The rotation member may for example be part of a second gear wheel, a bevel gear, a worm drive wheel, or any other type of gear-like connection as long as a rotation of the second linkage member translates into a rotation of the caster wheel module about the third axis of rotation. Thus, the transfer of rotation from a site of for example a servo motor driving the rotation of the second linkage member is made possible in a simplified manner. Hereby, a motor driving the rotation of the second linkage member and thus also the caster wheel module may be placed away from the caster wheel arrangement, for example close to the seat or otherwise not adjacent to the caster wheel arrangement. In this way, a less bulky and more convenient drive for the rotation of the caster wheel module is possible. For example, a rotation of the second linkage member about an axis along a longitudinal extension of the second linkage member may be transferred to the caster wheel module almost regardless of the angle between the second linkage member and the caster wheel module surface via the rotation member being e.g. a bevel gear.

According to at least one exemplary embodiment of the invention, the caster wheel arrangement may further comprise a second wheel rotatably arranged about the first axis of rotation to the first linkage member adjacent to the first wheel. A second wheel is advantageous for situations where heavy loads are carried by the caster wheel arrangement. Thereby, more than one wheel supports the heavy load. Furthermore, by using two wheels compared to when having a larger single wheel, a rotation about the second axis of rotation of the caster wheel module is facilitated due to the smaller contact surface, thereby also less friction, with the ground.

According to a second aspect of the invention, there is provided a powered wheelchair comprising a caster wheel arrangement as according to any of the previous aspects and/or embodiments, wherein the wheel is arranged as a rear wheel of the powered wheelchair. A powered wheelchair is provided with a motor providing power for driving the wheelchair in a desired direction. The powered wheelchair may for example have two motors, one for each of two powered wheels providing the driving motion for the wheelchair. The caster wheel arrangement arranged on the electric wheelchair provides for improved steering control of the wheelchair, in particular when turning. With the caster wheel arrangement, a driver may maintain the speed throughout a turning maneuver without compromising the steering or driving control of the wheelchair. Furthermore, the caster wheel arrangement enables overcoming obstacles such as a curb by rotating the caster wheel module and thereby using the engaging element. Furthermore, the engaging element provides for a breaking function.

According to an embodiment of the invention, the powered wheelchair may comprise a control unit configured to control the caster wheel module to rotate around the third axis of rotation such that the second axis of rotation is tilted towards a driving direction of the wheelchair. In other words, the rotation of the caster wheel module about the third axis of rotation is such that a portion of the second axis of rotation above the wheel is tilted in the driving direction. For example, assume the caster wheel arrangement is arranged at the rear of the wheelchair. Then, the caster wheel module will be rotated about the third axis of rotation such that the caster wheel module, with the wheel in contact with the ground, is translated further in the rearward direction of the wheelchair.

The control unit may further be configured to, when the wheelchair is driving on a substantially flat ground, for example on a side walk, to control the rotation of the caster wheel module about the third axis of rotation, via for example a gear wheel arrangement, such that the second axis of rotation is essentially perpendicular to the ground. Such control may for example be automatically enabled, using a feedback system, when driving at below a certain speed and/or at below a predetermined turning ratio where oversteering may not have to be compensated for.

The control unit is preferably a micro processor or any other type of computing device. Similarly, a computer readable medium having stored thereon program code may be any type of memory device, including one of a removable nonvolatile/volatile random access memory, a hard disk drive, a floppy disk, a CD-ROM, a DVD-ROM, a USB memory, an SD memory card, or a similar computer readable medium known in the art.

According to at least one exemplary embodiment of the invention, the control unit may be configured to position the caster wheel module to a rotational angle by rotation about the third axis or rotation depending on a driving speed of the powered wheelchair. In other words, the control unit is configured to rotate the caster wheel module a rotational angle, for example a portion of a complete turn, depending on the driving speed. For example, the rotational angle may be 5 degrees. By rotating the caster wheel module, thus positioning the caster wheel module at a rotational angle, based on the driving speed enables adaptive steering control. For example, at high speeds the rotational angle should be larger than at low speeds. Thus, providing improved reduction of oversteering. The rotational angle may be an angle of the second axis with respect to a vertical axis from a point on the ground which the wheel is in contact with.

According to at least one exemplary embodiment of the invention, the powered wheel chair may further comprise a gyroscope and/or an accelerometer configured to determine a signal indicative of a slope angle of a ground supporting the powered wheelchair, wherein the tilt angle of the caster wheel module depends on the slope angle. The slope angle may advantageously be used for improving the driving characteristics of the powered wheel chair. For example, when ground is downhill, uphill or slanted, the signals from the accelerometer and/or gyroscope may be used to influence the tilt angle α of the caster wheel module.

Further effects and features of this second aspect of the present invention are largely analogous to those described above in connection with the first aspect of the invention.

According to a third aspect of the present inventive concept there is provided a method of controlling a caster wheel module arranged as a rear wheel arrangement on an powered wheelchair, the caster wheel module comprising: a wheel rotatably connected to a first linkage member, wherein the wheel is rotatably arranged about a first axis of rotation of the wheel; and a support element rotatably connected to the first linkage member through a joint configured to allow a rotation of the first linkage member relative to the support element around a second axis of rotation perpendicular to the first axis of rotation; a second linkage member connected to the support element at a third axis of rotation, wherein the third axis of rotation is essentially perpendicular to the second axis of rotation of the first linkage member, to allow rotation of the caster wheel module about the third axis of rotation, wherein the third axis of rotation passes adjacent to the second axis of rotation, wherein the method comprises the steps of: controlling the caster wheel module to rotate about the third axis of rotation.

According to at least one exemplary embodiment of the invention, the method may further comprise: acquiring a driving speed of the powered wheel chair; and controlling the caster wheel module to rotate about the third axis of rotation a rotational angle depending on the driving speed of the powered wheelchair.

According to at least one exemplary embodiment of the invention, the rotational angle may be proportional to the driving speed.

According to at least one exemplary embodiment of the invention, the method may further comprise determining a slope angle of a ground supporting the caster wheel module, and controlling the caster wheel module to rotate about the third axis of rotation a rotational angle depending on the slope angle. The slope angle of the ground may advantageously be obtained using an accelerometer and/or a gyroscope.

According to at least one exemplary embodiment of the invention, the method may comprise a step of: controlling the rotation about the third axis of rotation of the caster wheel module such that the second axis of rotation maintains vertical to a plane parallel to a ground in contact with the wheel. In this way, in situations where oversteering may not need to be reduced, for example when driving the wheelchair at low speeds, the caster wheel module be rotated such that the second axis of rotation maintains a vertical angle with the ground. Thereby, the wheel (and the first linkage member) may easily rotate about the second axis or rotation maintaining the caster wheel function. The controlling of the rotation may in this case be controlled by the control unit.

Further effects and features of this third aspect of the present invention are largely analogous to those described above in connection with the first and second aspects of the invention.

Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF DRAWINGS

These and other aspects of the present invention will now be described in more detail, with reference to the appended drawings showing currently preferred embodiments of the invention, wherein:

FIG. 1 schematically shows an exemplary caster wheel arrangement according to an embodiment of the invention mounted on a powered wheel chair;

FIG. 2a-b schematically show an exemplary caster wheel arrangement according to an embodiment of the invention:

FIG. 3 schematically shows a perspective cross-section of an exemplary caster wheel arrangement according to an embodiment of the invention:

FIG. 4a-b show an exemplary function of an exemplary embodiment of the invention;

FIG. 5a-b show an exemplary function of an exemplary embodiment of the invention; and

FIG. 6 is a flow-chart illustrating a method according to an exemplary embodiment of the invention.

### DETAILED DESCRIPTION OF EMBODIMENTS OF THE INVENTION

In the following description, the present invention is mainly described with reference to a caster wheel arrangement to be arranged on a wheelchair. However, the invention is equally applicable to other vehicles, trolleys, or similar.

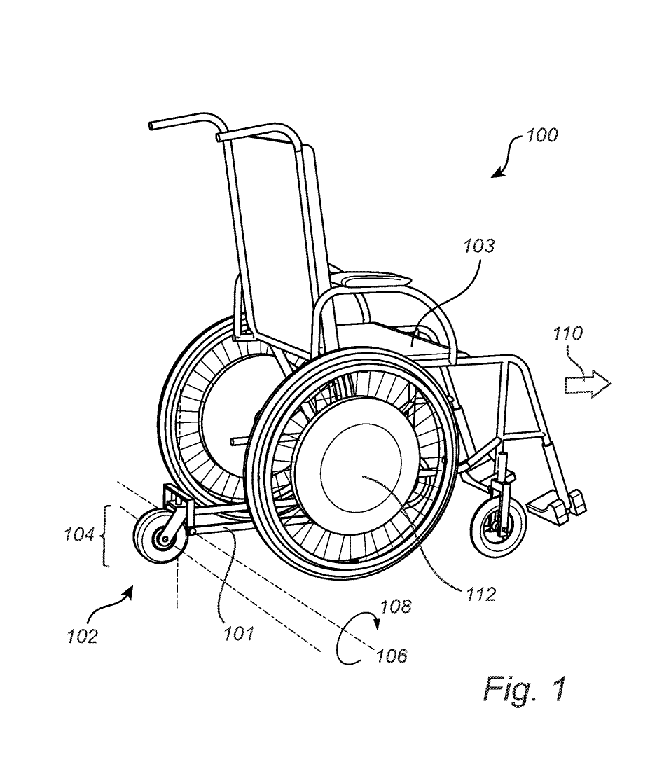

FIG. 1 shows a powered wheelchair according to an exemplary embodiment of the invention. The powered wheelchair 100 may be powered by an electrical motor (not shown) and may further comprise a control unit (not shown). The powered wheelchair 100 comprises a caster wheel arrangement 102 according to an embodiment of the invention. The control unit may for example be arranged under the seat 103 of the wheelchair 100. The caster wheel arrangement 102 comprises a caster wheel module 104 and a second linkage member 101 as will be described with reference to subsequent drawings. The caster wheel module 104 may be connected to a chassis (for example at a location under the seat 103) of the wheelchair via for example a servo motor for controlling the position of the caster wheel module 104 with respect to the ground and/or the chassis. The second linkage member 101 may be rotatably connected to the chassis via e.g. the servo motor. The control unit here is configured to control the caster wheel arrangement 102 such that the caster wheel module 104 is rotated about a third axis 106 of rotation in a direction 108 towards a driving direction 110 of the wheel chair 100. The rotation of the caster wheel module 104 provides improved control of the powered wheel chair when turning. By rotating the caste wheel module 104 an amount depending on speed during the turning action of the powered wheel chair 100, oversteering may be reduced. The term oversteering means that the wheelchair turns more (with a smaller radius of curvature) than expected by a driver operating the wheelchair. Furthermore, the control unit may be configured to increase the angle (or amount of) of rotation as a response to an increased driving speed of the wheelchair. As an example, the motor providing power to the powered wheel chair may be arranged in the hub 112 of the wheels of the powered wheel chair 100. For example, the electrical motor may have rotor and stator elements arranged coaxially with the circumference of the wheel rim and adjacent to a bearing allowing the wheel to rotate. The design and layout of the wheelchair as depicted in FIG. 1 is only for illustrative purposes and is thus only an example. The location of certain parts such as wheels or the control unit is not limiting the scope of the invention but is only to be considered as an example.

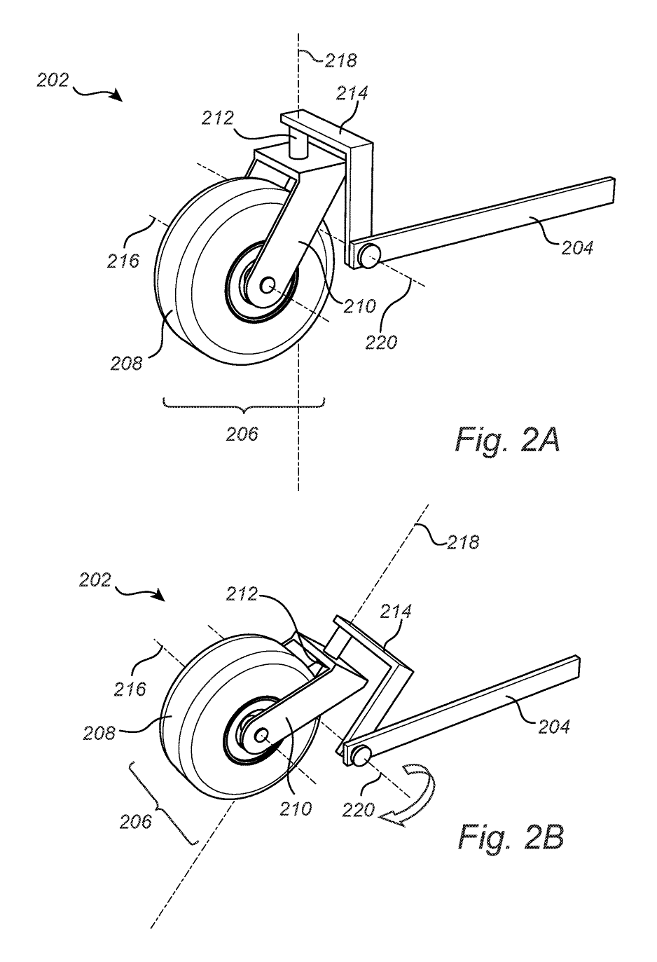

FIG. 2a illustrates an exemplary caster wheel arrangement 202 according to an embodiment of the invention. The caster wheel arrangement 202 may be implemented on a powered wheelchair as described in FIG. 1. FIG. 2a shows a second linkage member 204 and a caster wheel module 206 comprising a wheel 208, a first linkage member 210, a joint 212 and a support element 214. FIG. 2a shows the non-powered wheel 208 connected to the first linkage member 210. The wheel 208 here is non-powered which means that no power from a motor or similar is supplied to drive the wheel 208. Furthermore, the wheel 208 is connected in a rotatable manner to the first linkage member 210 at the center of rotation of the wheel, the center of rotation is along the first axis 216 of rotation. Hence, the wheel may rotate about the first axis of rotation 216. Moreover, the support element 214 is connected to the first linkage member 210 via the joint 212. The joint 212 is configured to allow the first linkage member 210 to rotate about a second axis 218 of rotation with respect to the support member 214. Preferably the rotation about the second axis 218 of rotation is the only degree of freedom of the joint 212. In other words, the joint 212 may typically not allow rotation about any other axis than the second axis 218 of rotation. Furthermore, the second axis 218 of rotation is perpendicular to the first axis 216 of rotation, or at least an axis parallel to the second axis 218 of rotation is perpendicular to the first axis 216 of rotation. For example, the second axis of rotation 218 may be offset from the first axis of rotation, which means the first axis of rotation 216 and the second axis of rotation 218 do not intersect. In such case, an axis parallel to the second axis 218 of rotation is perpendicular to the first axis 216 of rotation. The second linkage member 204 is connected to the support element 214 at a third axis 220 of rotation. The third axis 220 of rotation is essentially perpendicular to the second axis 218 of rotation, or at least an axis parallel to the third axis 220 of rotation is essentially perpendicular to the second axis 218 of rotation. The provision of essentially perpendicular should be interpreted as that a small deviation from perpendicular is fine as long as the function of the caster wheel arrangement 202 is not substantially affected. Hereby, the second linkage member 204 is arranged to allow rotation of the caster wheel module 206 about the third axis 220 of rotation. Furthermore, the third axis of rotation 220 passes adjacent to the second axis 218 of rotation. In other words, the second linkage member 204 is arranged such that the third axis of rotation 220 passes adjacent to the second axis of rotation 220. Furthermore, in the depicted embodiment, the third axis of rotation 220 passes adjacent to the first linkage member 210.

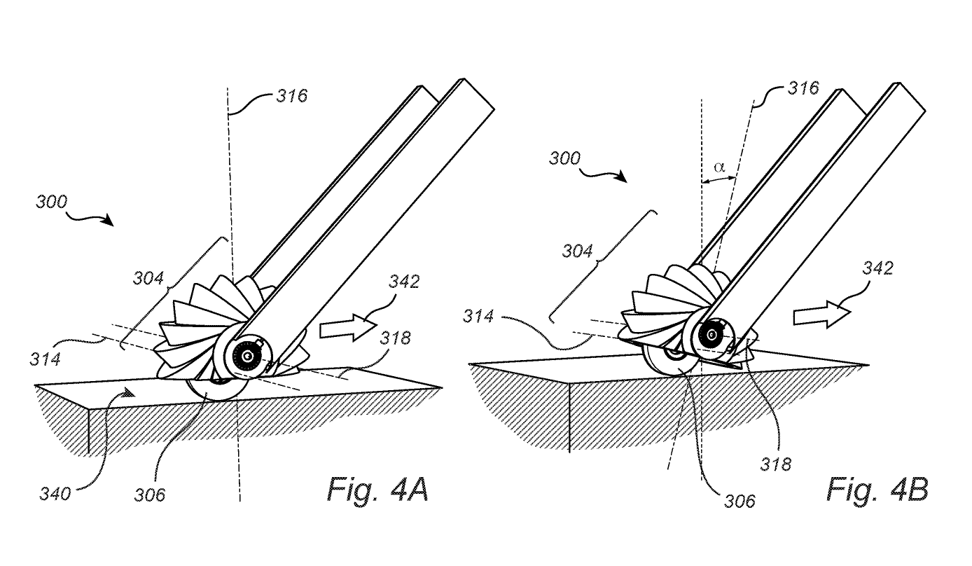

FIG. 2b shows the caster wheel arrangement 202 in FIG. 2a, with the caster wheel module 206 rotated about the third axis or rotation 220. Thus, as is shown in FIG. 2b, the second axis of rotation 218 has been tilted compared to what is shown in FIG. 2a. The second axis of rotation 218 has been tilted by a rotation about the third axis 220 of rotation. Thereby, the support element 214, the first linkage member 210, and the joint 212 have also been rotated about the third axis 220 of rotation. By tilting about the third axis of rotation 220, oversteering may be reduced in a turning situation with the caster wheel arrangement 202 mounted as e.g. a rear wheel on a powered wheelchair. A consequence of tilting the second axis of rotation 218 by a rotation about the third axis of rotation 220 is that the rotation of the wheel 208, the first linkage member 210, and the joint 212 (e.g. the caster wheel module 206) about the second axis of rotation is limited when the wheel 208 is rolling on the ground. In FIG. 2a, the rotation (allowed by the joint 212) about the second axis 218 is less limited due to the vertically positioned second axis 212 (see also FIG. 4) which means the weight supported by the wheel is perpendicular to the ground (see FIG. 4) in contrast to the situation in FIG. 2a. The rotation about the third axis of rotation 220 may be controlled by a control unit as a function of speed of the wheelchair.

In some exemplary embodiments, the wheel 208 is a first wheel and there is a second wheel arranged adjacent to the first wheel 208. The second wheel is rotatably arranged to the first linkage member 210 about the first axis of rotation 216. Thus, the fork-like shape of the first linkage member 210 is wider such that the second wheel fits inside the fork-shape. However, other configurations are possible, for example having a similar second fork-shaped linkage member next to the first linkage member 210 as long as the first and second wheels share the same first axis of rotation 216.

The rotation (only shown in one direction, however in both directions are possible) depicted in FIGS. 2a-b may further be used for controlling the second axis of rotation 218 to be vertical to a plane parallel to the ground. For example, at low speeds when oversteering may not have to be reduced, it is advantageous for the second axis of rotation 218 to be vertical with the ground in order for the wheel 208 and the first linkage member 210 to easily rotate about the second axis of rotation. A situation where the second axis of rotation 218 may not be vertical to the ground, thus a rotation may be desired, is for example when driving over a bump, or an otherwise uneven surface. In this way, the wheel easily turns about the second axis or rotation 218 and thereby aligns with a driving direction 110.

It should be noted that the rotations mentioned above may be in two opposite directions. For example, although the rotation about the third axis of rotation 220 is depicted to be in one direction (e.g. indicated by the arrow about axis 220), the rotation is also possible in the other direction.

In FIG. 2a-b the third axis of rotation 220 passes through the wheel 208 in the depicted position of the wheel 208. Naturally the third axis of rotation 220 may not pass through the wheel in some positions of the wheel 208, for example, at some position of the wheel 208 if the wheel 208 is rotated about the second axis of rotation 218 a full turn. Moreover, the third axis of rotation 220 passes adjacent to the second axis of rotation 218.

Furthermore, if the caster wheel arrangement 202 is mounted on a powered wheelchair 100 as a rear wheel, the caster wheel arrangement 202 is arranged such that if the caster wheel module is rotated about the third axis of rotation 220 the second axis of rotation 218 is tilted towards a driving direction 110 of the powered wheel chair 100. Thus, the third axis of rotation 220 is essentially perpendicular to the driving direction 110 of the powered wheel chair 100.

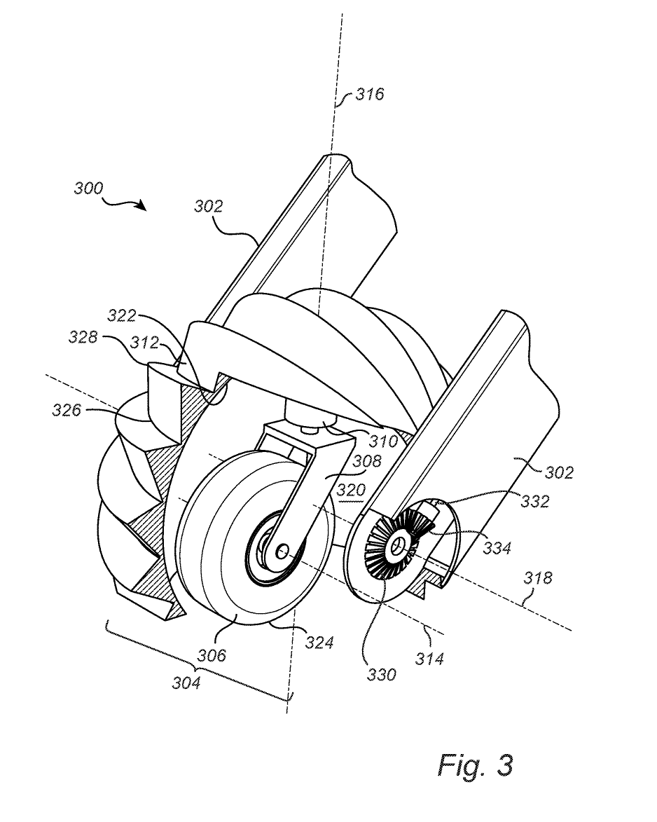

FIG. 3 schematically illustrates perspective cross-section of a caster wheel arrangement 300 according to an exemplary embodiment of the present invention. FIG. 3 shows a second linkage member 302 and a caster wheel module 304 comprising a wheel 306, a first linkage member 308, a joint 310 and a support member 312. Similar to the depicted exemplary embodiment in FIG. 2a-b, the first linkage member 308 is rotatably connected to the wheel 306 at a first axis 314 of rotation. The first linkage member 308 is connected to the support member 312 via the joint 310 such that the first linkage member 308 may rotate about a second axis 316 of rotation with respect to the support member 312. Moreover, the second linkage member 302 is rotatably connected to the support member 312 at a third axis 318 of rotation substantially perpendicular to the second axis 316 of rotation. One difference between the embodiment in FIG. 3 and the embodiment in FIGS. 2a-b is that in FIG. 3, the support member 312 is in the form of a housing 312 forming a compartment 320 for the wheel 306. In addition, the third axis of rotation 318 passes adjacent to a center of the compartment 320. This allows the caster wheel module to rotate about the third axis of rotation 318 without substantially interfering with a position in a vertical direction of a wheelchair having the caster wheel module 304. In addition, the third axis of rotation 318 passes adjacent to the second axis of rotation 316. Furthermore, the first linkage member 308 and the joint 310 are located in the compartment 320 and the joint 310 is connected, for example via a bolt or screw, to an inner surface 322 of the support element 312. In addition, a portion 324 of the wheel 306 here extends outside the compartment 320 through an open end (more clearly seen in FIGS. 4a-b) of the support element 312. In the depicted exemplary embodiment, the open end is located substantially opposite the joint 310 with respect to the wheel 306. On the outside surface of the support element, there are provided engaging elements 326, 328 in the form of grooves 326 and ribs 328. The engaging elements 326, 328 may be similar to the engaging features of a terrain tire. The support member 312 may be made from a plastic material, such as for example abs-plastic (Acrylonitrile butadiene styrene) or glass fiber reinforced plastic.

Furthermore, on the support element 312 there is arranged a gear wheel 330 with a centre axis of the gear wheel 330 determining the third axis 318 of rotation. Thus, by rotating the gear wheel 330 about the centre axis, the caster wheel module 304 rotates about the third axis 318 of rotation. For example, as shown in FIG. 3, the second linkage member 302 comprises a rotatable shaft 332 having a rotation member 334 in the form of a second gear wheel 334. If the rotatable shaft 332 is rotated, the second gear wheel 334 causes the first gear wheel 330 to rotate and thereby the caster wheel module 304 is also rotated about the third axis 318 of rotation. In the depicted embodiment in FIG. 3, a bevel gear arrangement 334,330 is shown as an example.

FIG. 4a-b illustrate the caster wheel arrangement 300 in FIG. 3 in two different positions. Similar to what is shown in FIG. 3, in FIG. 4a-b the caster wheel module 304 comprises the wheel 306 having the first axis of rotation 314, and via the joint a rotation of the wheel 306 about a second axis 316 of rotation is possible. A portion of the wheel 306 extends through on open end such that the wheel 306 may touch the ground 340. There is further indicated a third axis 318 of rotation of the caster wheel module 304. In FIG. 4a, the caster wheel module 304 is in an upright position, thus non-rotated. For example, as illustrated, the second axis of rotation 316 is substantially perpendicular to the ground 340. In FIG. 4b, the caster wheel module 304 has been rotated about the third axis 318 of rotation compared to what is depicted in FIG. 4a. In FIG. 4b, the second axis 316 of rotation is not perpendicular to the ground 340, instead the second axis 316 of rotation is tilted an angle α with respect to an axis perpendicular to the ground 340. Assuming a driving direction 342 indicated in FIG. 4a-b, the second axis 316 of rotation is tilted towards the driving direction 342. A consequence of tilting the second axis of rotation 318 by a rotation about the third axis of rotation 318 is that the rotation of caster wheel module 304 comprising the wheel 306, about the second axis of rotation is limited when the wheel 306 is rolling on the ground 340. This is due to that the weight supported by the wheel 306 is not aligned with the second axis of rotation 316 leading to a more constraint ability for a rotation about the second axis of rotation 316. Thereby, when the wheelchair (e.g. as shown in FIG. 1) turns, the caster wheel module 304 being rotated an angle α may not rotate about the second axis of rotation 316 as easily. A typical angle of rotation α is in the interval of 0°-10°. Furthermore, the angle of rotation α is proportional to a driving speed of a wheelchair comprising the caster wheel arrangement, for example as depicted in FIG. 1. For example, at a driving speed of 15 km/h, α may be approximately 10°.

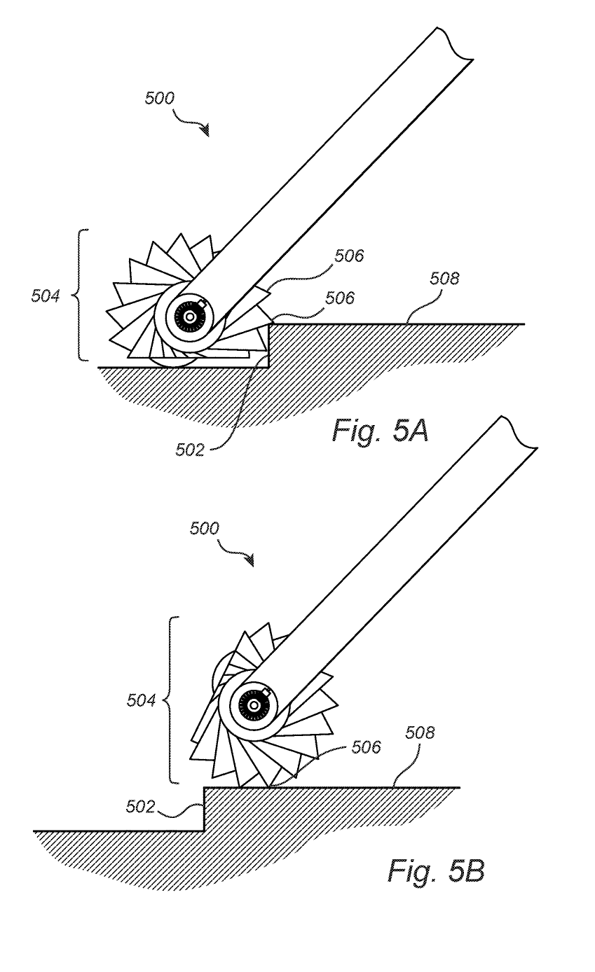

FIG. 5a-b Illustrates a caster wheel arrangement 500 is shown. In FIG. 5a-b the caster wheel arrangement 500 is shown as it climbs over an obstacle in the form of a curb. The caster wheel arrangement 500 is similar to the caster wheel arrangement in FIG. 3 and FIG. 4a-b. The caster wheel arrangement 500 may be mounted on e.g. a powered wheelchair. As the caster wheel arrangement 500 approaches the curb 502, the caster wheel module 504 is rotated about the third axis of rotation (316 in FIG. 4a-b). This way, the engaging elements 506 (not all are numbered in order to avoid cluttering in the drawing) engage with the curb 502, and as the caster wheel module 504 rotates about the third axis (316) of rotation, the caster wheel arrangement 500 climbs up to the upper surface 508 of the curb 502 as is shown in FIG. 5b. Furthermore, with the caster wheel module rotated, for example as shown in FIG. 5b, the caster wheel module effectively works as a hand-break for a powered wheelchair.

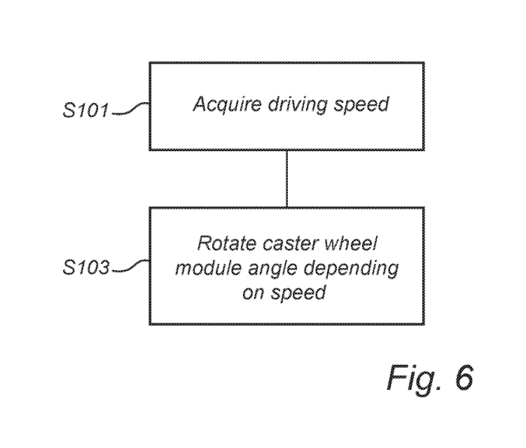

FIG. 6 shows a flow-chart describing an exemplary method according to an embodiment of the invention. The method is for controlling a caster wheel arrangement 202, 300 arranged as a rear wheel arrangement on a powered wheelchair 100. A caster wheel module 206, 304 of the caster wheel arrangement is rotatable about a third axis of rotation 220, 318 as described in e.g. FIG. 2a-b, FIG. 4a-b, and/or FIG. 5a-b. The method comprises an optional first step S101 of acquiring a driving speed of the powered wheelchair. In a subsequent step S103, the caster wheel module 206, 304 is rotated a rotational angle about the third axis 220, 318 of rotation depending on the driving speed of the powered wheelchair, for example, the higher the speed the larger the rotational angle.

Thanks to the present invention, there is provided a system and method capable of an improved control of a powered wheel chair. In particular, there is provided a system and method capable of reducing the effect of oversteering of a powered wheelchair when turning at a high speed.

In each of the above exemplary embodiments in FIGS. 1-6 and in other embodiments, a typical size of the wheel is in the interval between 150 mm and 250 mm in diameter and a wheel width in the interval between 50 mm and 70 mm, however, these measures may be different and are only for exemplary purposes. The rim of the wheel is commonly made from aluminum and the tire is typically a rubber tire, although other materials may also be used.

Furthermore, powered wheel chair 100 may also be equipped with sensors such as e.g. a gyroscope and/or an accelerometer. As mentioned (e.g. with reference to FIG. 4a-b) the caster wheel tilt angle α may be controlled between e.g. 0°-10° proportionally with actual speed of the powered wheel chair 100. However, it may be advantageous to include more signals which affect tilt angle, other than speed. For example, when ground is downhill, uphill or slanted, the signals from the accelerometer and/or gyroscope may also be used to influence tilt angle α, in order to enhance driving characteristics. In one exemplary embodiment, an accelerometer measuring the acceleration in three perpendicular directions (e.g. axes X, Y, Z) and a gyroscope measuring rotational speed about the axes X, Y, Z, of the powered wheel chair 100 are arranged to provide measurements for determining the slope angle of the ground. The measurements from the accelerometer and the gyroscope are combined with e.g. the geometry of the powered wheel chair 100 in order to determine the slope angle of the ground.

Furthermore, powered wheel chairs 100 typically have some type of steering device, usually a joystick. When traveling at high speed, which would suggest a high tilt angle α, a steering command from e.g. the joystick indicating a sharp turn, may require the tilt angle α to be temporarily reduced in order to obtain the desired turn

Additionally, variations to the disclosed embodiments can be understood and effected by the skilled person in practicing the claimed invention, from a study of the drawings, the disclosure, and the appended claims.

It should be understood that the inventive concept is not limited to the described exemplary embodiments; rather the scope being generally defined by the accompanying claims.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A caster wheel arrangement for a powered wheelchair, said caster wheel arrangement comprising:
a caster wheel module comprising:
a wheel rotatably connected to a first linkage member, wherein said wheel is rotatably arranged about a first axis of rotation of said wheel; and
a support element rotatably connected to said first linkage member through a joint configured to allow a rotation of said first linkage member relative to said support element around a second axis of rotation perpendicular to said first axis of rotation;
a second linkage member connected to said support element at a third axis of rotation, wherein said third axis of rotation is essentially perpendicular to said second axis of rotation of said first linkage member, to allow rotation of said caster wheel module about said third axis of rotation,
wherein said third axis of rotation passes adjacent to said second axis of rotation.

2. The caster wheel arrangement according to claim 1, wherein said second linkage member is rotatably connected to said support member.

3. The caster wheel arrangement according to claim 1, further comprising an engaging element for engaging to a surface, wherein said engaging element is arranged to be rotatable around said third axis of rotation.

4. The caster wheel arrangement according to claim 3, wherein said engaging element is rotatably arranged to said support element, wherein said engaging element is rotatable about said third axis or rotation independent of said support element.

5. The caster wheel arrangement according to claim 1, wherein said support element comprises a compartment for housing a part of the wheel, wherein a portion of said wheel extends outside said compartment through an open end of said compartment.

6. The caster wheel arrangement according to claim 5, wherein said third axis of rotation passes adjacent to a center of said compartment.

7. The caster wheel arrangement according to claim 5, wherein said open end extends in a plane and is arranged opposite said joint with respect to said wheel.

8. The caster wheel arrangement according to claim 5, wherein said engaging element is a rough outside surface of said support element.

9. The caster wheel arrangement according to claim 1, wherein said caster wheel module comprises a gear wheel for enabling a rotation of said caster wheel module, said gear wheel arranged such that a centre axis of said gear wheel defines said third axis of rotation of said caster wheel module.

10. The caster wheel arrangement according to claim 9, wherein said second linkage member comprises a rotation member, wherein said gear wheel is connected to said rotation member arranged on said second linkage member and configured to transfer a rotation of said second linkage member into a rotation of said caster wheel module via said gear wheel and said rotation member.

11. The caster wheel arrangement according to claim 1, wherein said wheel is a first wheel, said caster wheel arrangement further comprising a second wheel rotatably arranged about said first axis of rotation to said first linkage member adjacent to said first wheel.

12. A powered wheelchair comprising a caster wheel arrangement according to claim 1, wherein said wheel is arranged as a rear wheel of said powered wheelchair.

13. The powered wheelchair according to claim 12, comprising a control unit configured to control said caster wheel module to rotate around said third axis of rotation such that said second axis of rotation is tilted towards a driving direction of said powered wheelchair.

14. The powered wheelchair according to claim 13, wherein said control unit is configured to position said caster wheel module to a rotational angle by rotation about said third axis or rotation depending on a driving speed of said powered wheelchair.

15. The powered wheelchair according to claim 12, further comprising a gyroscope and/or an accelerometer configured to determine a signal indicative of a slope angle of a ground supporting said powered wheelchair, wherein said tilt angle of said caster wheel module depends on said slope angle.

16. A method of controlling a caster wheel module arranged as a rear wheel arrangement on a powered wheelchair, said caster wheel module comprising:
a wheel rotatably connected to a first linkage member, wherein said wheel is rotatably arranged about a first axis of rotation of said wheel; and
a support element rotatably connected to said first linkage member through a joint configured to allow a rotation of said first linkage member relative to said support element around a second axis of rotation perpendicular to said first axis of rotation;
a second linkage member connected to said support element at a third axis of rotation, wherein said third axis of rotation is essentially perpendicular to said second axis of rotation of said first linkage member, to allow rotation of said caster wheel module about said third axis of rotation,
wherein said third axis of rotation passes adjacent to said second axis of rotation,
wherein said method comprises the steps of:
controlling said caster wheel module to rotate about said third axis of rotation.

17. The method according to claim 16, further comprising:
acquiring a driving speed of said powered wheel chair; and
controlling said caster wheel module to rotate about said third axis of rotation a rotational angle depending on said driving speed of said powered wheelchair.

18. The method according to claim 16, further comprising:
determining a slope angle of a ground supporting the caster wheel module, and
controlling said caster wheel module to rotate about said third axis of rotation a rotational angle depending on said slope angle.

19. The method according to claim 16, further comprising a step of:
controlling said rotation about the third axis of rotation of said caster wheel module such that said second axis of rotation maintains vertical to a plane parallel to a ground in contact with said wheel.
